(19) United States
(12) Patent Application Publication
(10) Pub. No.: US 2015/0100929 A1
(43) Pub. Date: Apr. 9, 2015

(54) REVERSE SYNTHESIS OF DIGITAL NETLISTS

(71) Applicant: Raytheon Company, Waltham, MA (US)

(72) Inventors: Mark W. Redekopp, Los Angeles, CA (US); Parviz Saghizadeh, Los Angeles, CA (US)

(21) Appl. No.: 14/454,343

(22) Filed: Aug. 7, 2014

Related U.S. Application Data
(60) Provisional application No. 61/887,940, filed on Oct. 7, 2013.

(51) Int. Cl. G06F 17/50

(52) U.S. Cl. CPC G06F 17/5045
USPC 716/103

(57) ABSTRACT

A method and method of extracting information from a netlist. The netlist for a device under test (DUT) is read and a circuit selected to be transformed. Transformation candidates are identified using transformation specific criteria and verification methods are applied to prove the transformation is equivalent to the circuit being transformed. If the candidate transformation is equivalent to the circuit being transformed, the system commits to the transformation. If the candidate transformation is not equivalent to the circuit being transformed, the transformation is undone.

### CLAIM OF PRIORITY

This application claims the benefit of U.S. Provisional Patent Application Ser. No. 61/887,940, filed on Oct. 7, 2013, the content of which is incorporated herein by reference in its entirety.

### GOVERNMENT RIGHTS

This invention was made with Government support under government contract HR0011-11-C-0058, awarded by the Department of Defense. The Government has certain rights in this invention.

### BACKGROUND

Many system developers use integrated circuits (ICs) that are fabricated in off-shore or untrusted foundries, bringing risk of counterfeit, unreliable, or even malicious alterations to the circuit. It can be difficult to verify that the integrated circuit is what the manufacturer says it is, and to detect malicious or suspect circuitry in an integrated circuit.

Destructive and non-destructive reverse engineering techniques such as SEM imaging, X-ray and other techniques can be used to image an integrated circuit (IC) and produce a low level netlist that represents the circuitry in the digital IC. However, this extracted netlist is a raw netlist at the transistor level or at best at the elementary gate level. For large and complex digital ICs it is extremely hard if not impossible to understand the function of the design by examining the low level netlist in its raw form. In order to understand the functionality of the digital IC, whether it meets specifications, or if the IC is compromised, the netlist needs to be converted to a human-readable higher level netlist. Currently, there are no automated techniques to extract hierarchy and functionality from a transistor or gate level netlist.

### BRIEF DESCRIPTION OF THE DRAWINGS

FIG. 1 illustrates a reverse synthesis technique to extract hierarchy and functionality from a gate level digital netlist.

FIG. 2 illustrates a technique of identifying possible transformations;

FIGS. 3a-3d illustrate an example of application of reverse synthesis to netlists of digital cells;

FIG. 4 illustrates a sea of gates circuit transformed into a register-transfer level (RTL) netlist;

FIG. 5 illustrates another example of a sea of gates circuit transformed into a high level RTL netlist;

FIG. 6 illustrates a technique of adding an integrated circuit to a supply chain; and

FIG. 7 illustrates an example reverse synthesis system.

### DETAILED DESCRIPTION

The following description and the drawings illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Deriving the function and connectivity of a chip can allow verification to the actual design either by software equivalence checkers or by manual inspection. We present a set of techniques that are processes and/or physical implementations embodied in software, hardware, and/or firmware to take a gate-level description, recognize common digital logic structures and reproduce equivalent register-transfer level (RTL) descriptions of the circuit that are amenable to automated or manual verification.

In one embodiment, these techniques use characteristic gate-level and structural patterns for possible transformations to identify possible partitions of gates implementing a specific high-level function. They then use formal verification algorithms to prove/disprove the candidate groups of gates for a particular function, to write out a hardware description language (HDL) description using more abstract operators in RTL and to perform this process iteratively so that complex functions (e.g., shifter, 32-bit adder) can be identified from more basic functions (e.g., mux, full-adder, etc.)

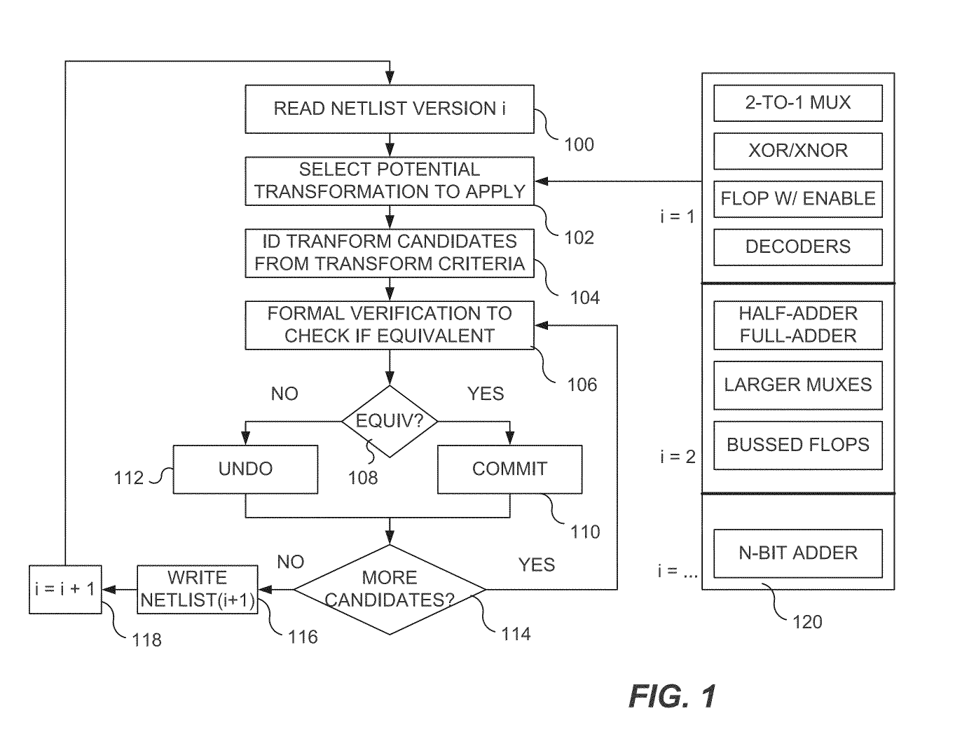

An example of reverse synthesis of a digital integrated circuit (IC) is shown in FIG. 1. In the approach shown in FIG. 1, the technique extracts hierarchy and functionality from an integrated circuit by iteratively performing a series of transformations on a sea-of-gates netlist to group gates based on structural characteristics and then uses formal verification provers to check if the group of gates is equivalent to a particular functional abstraction and, if so, replacing the selected gates with the functional abstraction. The technique at each iteration could include reading, at 100, an input netlist as a sea of gates; selecting, at 102, a particular desired function/transformation to search for and identifying, at 104, transformation candidates from transformation specific criteria.

In one embodiment, the desired function/transformation is chosen from a library of functions/transformations at 120. Examples of these functions/transformations include multiplexers, flip-flops, decoders, half-adders, full-adders, etc. In some embodiments, the library grows to include more complex functions/transformations as more complex structures are identified. Transformation, as referred to throughout, refers to replacing a group of gates with its equivalent function. Transformation specific criteria are based on the function selected for transformation. In some embodiments, the technique creates a set of criteria based on the behavior, properties and characteristics of the selected function. In some such embodiments, the criteria include aspects such as fan-in and fan-out characteristics, clocking scheme, and signal connectivity. For instance, some characteristics of a bussed register are that it is made of a number of flip-flops, all clocked with the same clock. In addition, all may have the same Enable signal. Based on the established transformation criteria a group of potential candidates are identified for further processing. These candidates meet some or all of the transformation criteria. Doing so limits the search space and provides an intelligent starting point for the transformation process. In one embodiment, characteristics such as reconvergent fanout, intersection of fan cones and flop feedback are used to search for candidate gate groups.

In one embodiment, the technique combines structural pattern detection with Boolean formal verification provers to first identify and then verify the transformation. At 104 and 106, apply verification methods to “prove” the transformation. If not equivalent, undo the transformation at 112.

If equivalent at 108, move to 110, generate the transformed RTL description and replace the gate-level description with the equivalent RTL.

In one embodiment, this technique is run iteratively to induce several levels of hierarchy. In one such embodiment, we check, at 114, to determine whether more transformations can be made and, if so, move to 116, save the revised netlist and to 118 where the technique increments i before moving to 100. Repeat using the transformed netlist as the input netlist for next iteration.

This technique iteratively transforms a gate-level netlist to a functional model by identifying transformations and adding hierarchy. In one embodiment, the technique uses formal verification, not template matching, to identify candidates for transformation, searches for “Expected Properties”, uses graph connectivity to narrow the candidates, proves each candidate against an equivalent functional model and then performs the transformation.

In some embodiments, a user interface displays potential transformations to a user. In some such embodiments, a user reviews the displayed candidate transformation and can either accept the proposed transformation or choose an alternate transformation.

The technique of FIG. 1 provides a framework and process to transform a flat gate-level netlist (sea-of-gates) of a digital IC to more abstract functions and operators for the purpose of reverse engineering, functionality determination, hierarchy reintroduction, RTL-recovery, and/or IP infringement determination. It iteratively uses local characteristics/patterns to identify groups of gates as function candidates. And it uses formal verification (logic equivalence) to prove/disprove candidates, transforming proven candidates with their abstract function/representation. In one such embodiment, the result is a human readable RTL file that is used to determine the reliability of digital integrated circuits, to determine the functionality of integrated circuits for which no design data is available, to verify authenticity of a digital IC post fab (i.e., no malicious alterations, counterfeit parts, or trojans), and to compare the digital IC to its commercially available datasheet.

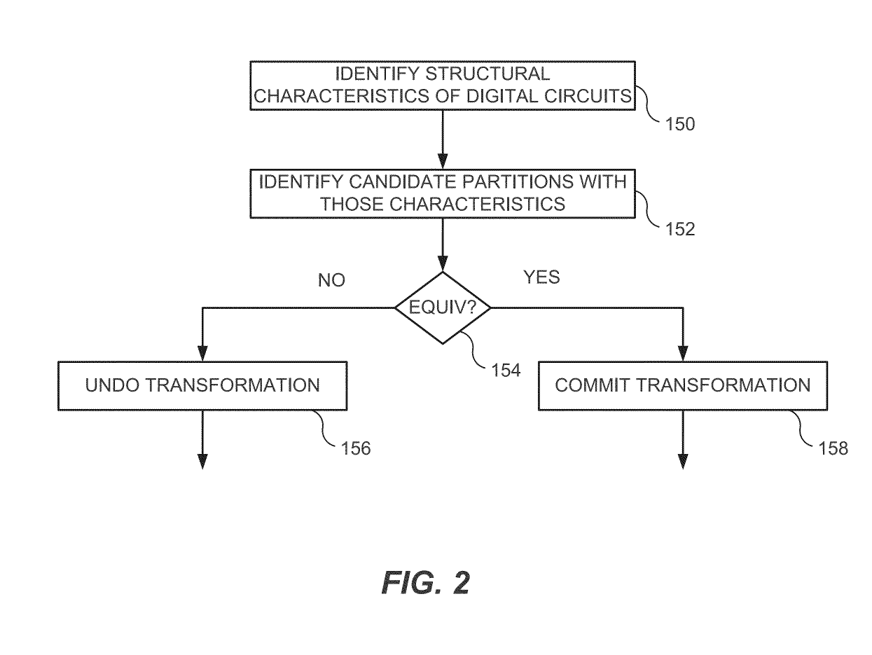

A technique of identifying possible transformations is illustrated in FIG. 2. In the technique of FIG. 2, a netlist of n gates is to be transformed into known structures. In one example embodiment, the technique identifies, at 150, structural characteristics of functions that could be in the IC. For example, there could be an adder, a decoder, a mux, and register circuits with common enable. In one such embodiment, the technique does this by examining connectivity, fan-in/fan-out signatures, and common signals that are invariant patterns of a particular structure.

Once candidate partitions have been identified at 152, the technique uses formal logic equivalence methods rather than simulation to prove the structure. In one embodiment, this is done because, for functions with a large number of inputs, exhaustive simulation is difficult while formal methods are often tractable. When a partition of gates is proven, at 154, to perform a particular function the technique replaces those gates in the netlist, at 158, with abstract RTL operators such as addition, if . . . then . . . else, always @(posedge clk), etc.). If a partition of gates is not proven, the transformation is discarded at 156.

This approach was applied to two different digital ICs for verification. When applied to a sample Serial to Parallel Converter circuit, the technique reduced the original 330 cells to a Reverse Synthesized netlist of 122 cells. When applied to a sample DAC circuit, the technique reduced the original 1014 cells to a Reverse Synthesized netlist of 244 cells.

An example application of this approach might begin by partitioning the design based on the state elements (flops) that are logically bussed together (e.g., updated on the same logical “enable” condition) and further refined by their distance from primary inputs and outputs. From this information, in some embodiments RTL-like clocked process [always @(posedge clk)] descriptions replace the flop cells in the netlist. Once flops are grouped into busses, the combinational logic associated with the fan-in cones of each bus is grouped. These logic cones are then processed in parallel to derive their function. Towards this end, an iterative process is included that seeks to apply low-level transformations (e.g., 2-to-1 muxes, equivalent XOR gates, etc.) first and build up to higher-level components (e.g., adders, counters, register arrays) (as in 120 in FIG. 1). To reduce the search space for these transformations, characteristic structural properties help to identify candidate gate groups as discussed above.

Next, formal model checking software proves that the candidate gates implement the functionality of the possible component. In some embodiments, the checking software uses Binary Decision Diagrams (BDD) to prove that the candidate gates implement the functionality of the possible component. If proven, the netlist cells corresponding to the gates are replaced with a higher level description of the component. This approach scales well with circuit size due to the partitioning into the cones of logic pertaining to buses of flops. Each set of cones is processed in parallel with only minimal result merging. Furthermore, a brute-force, uninformed search for transformation candidates is avoided through the use of structural properties to filter the search space. In addition, iteratively applying higher level transformations takes advantage of knowledge gained from previous iterations.

In some embodiments, reverse synthesis is performed on netlists of digital cells. Once again, an iterative technique is used to build up from low-level digital cells (e.g., 2-to-1 muxes, equivalent XOR gates, etc.) to higher-level components (e.g., adders, counters, register arrays).

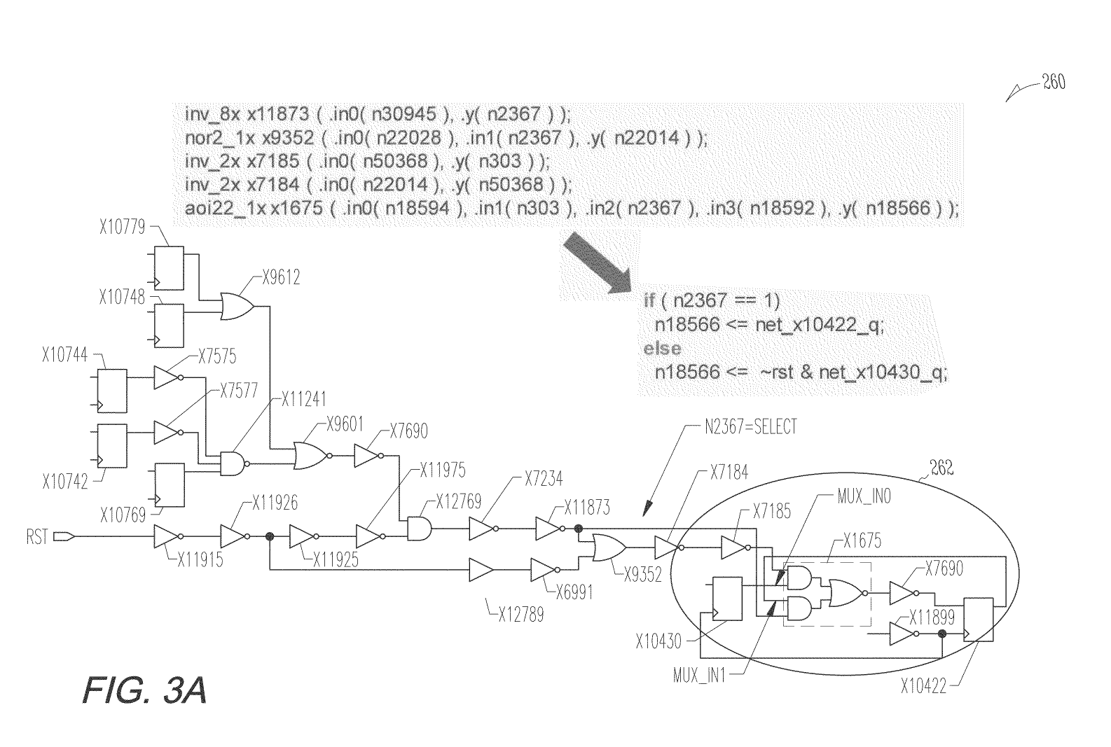

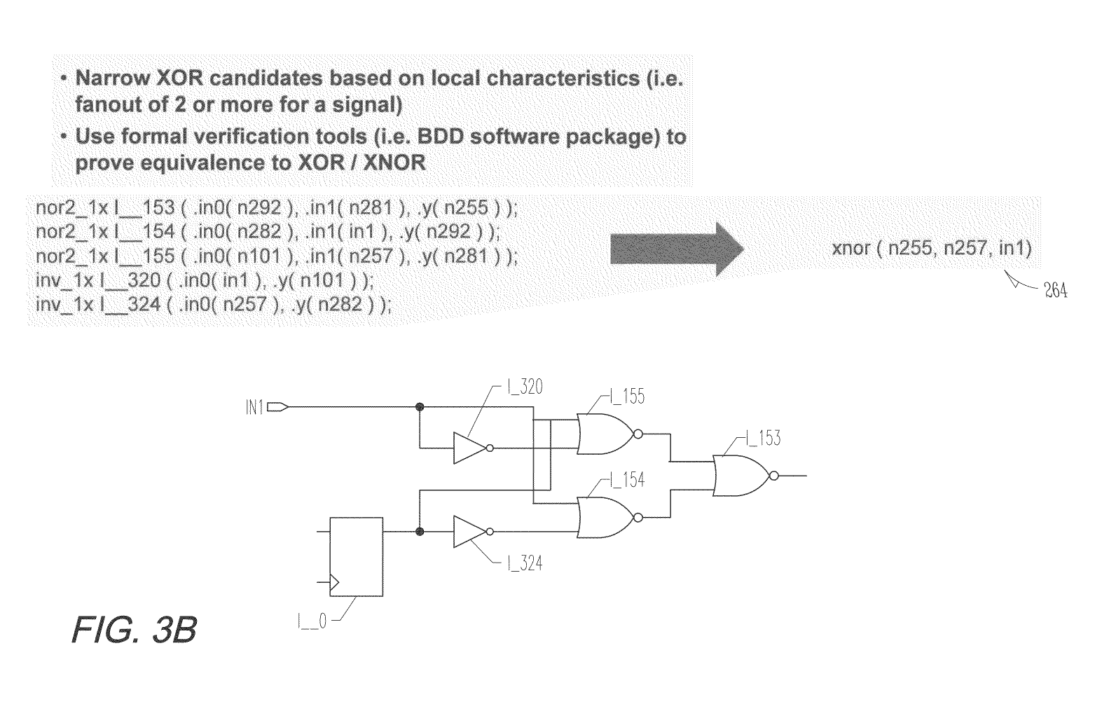

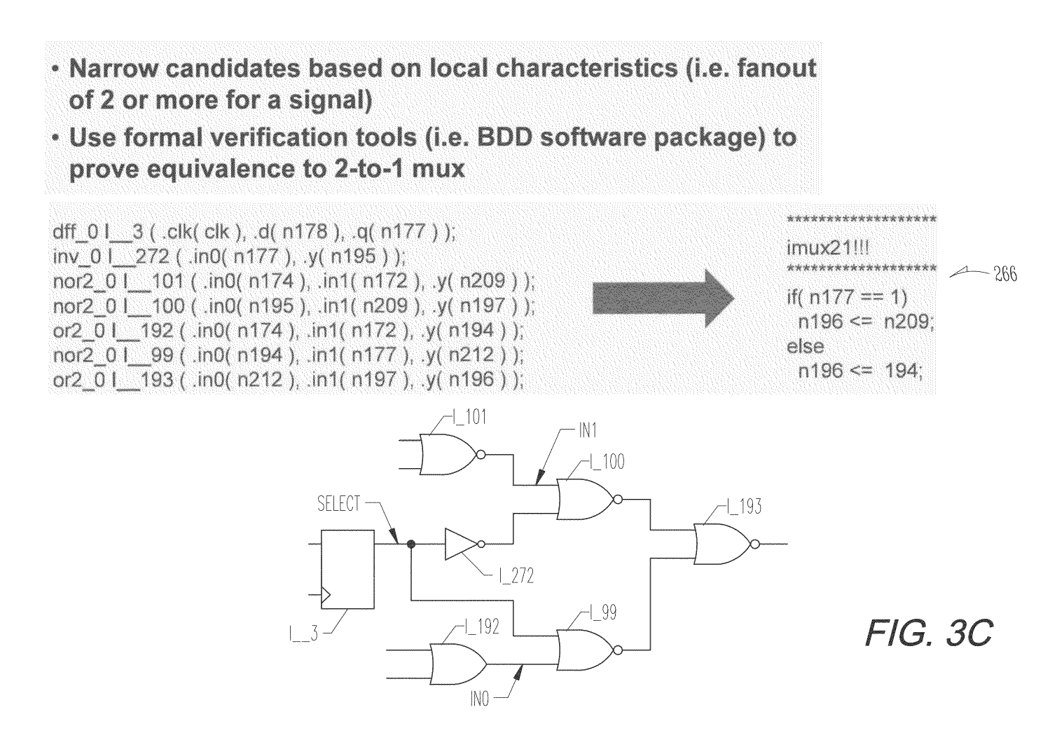

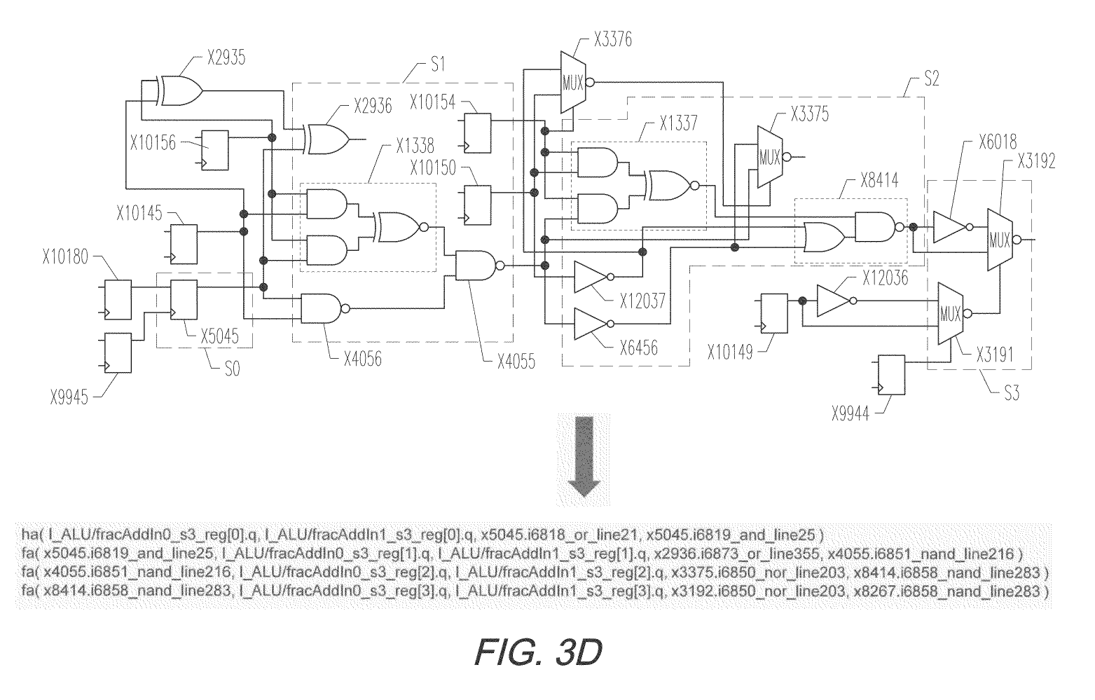

An example of application of reverse synthesis to a netlist of digital cells is shown in FIGS. 3a-3d. In the example circuit of FIG. 3a, a netlist which contains the selected gate descriptions shown in the upper left is read in (a subset of this netlist is shown for information purposes in schematic form in 260), and the user selects ‘mux’ from the library of transformations for which the technique will search. Rather than exhaustively trying all partitions of the gates in the netlist to determine which, if any, might form a mux, the technique uses connectivity patterns and structural characteristics of a mux (namely searching for the select signal fanning out to multiple gates and reconverging at the input) to narrow the possible partitions. Once a suitable partition has been found, the technique attempts to formally prove it is functionally equivalent to a mux. If successful, the technique generates a register transfer level description (shown as the ‘if . . . else’ statement in the figure) of that function and replace the gates in 262 with this more abstract description.

As another example, if a user selects ‘XOR/XNOR’ tranformations, the technique attempts to identify and then prove partitions of gates that form an XOR or XNOR functions. In FIG. 3b, the technique uses similar structural characteristics as described for the ‘mux’ in FIG. 3a since an XOR is equivalent to a mux where the two inputs: in0 and in1 are inverses of each other. By proving that a mux has this property using formal verification, the technique can then replace the individual gates with a more abstract representation of an ‘XOR’ shown at 264. Once again, the graphical illustration is provided simply to illustrate the underlying structures to be replaced.

In FIG. 3c, an example embodiment of a ‘MUX’ transformation is shown. In the example embodiment of FIG. 3c, the technique identifies possible candidates using transform-specific characteristics (i.e. invariant properties of a MUX) and then uses formal verification techniques to prove which candidate or candidates truly is a MUX. Once again, the MUX structure at 266 replaces the more obscure gate listing on the left, simplifying and clarifying the netlist.

In one embodiment, as shown in FIG. 3d, a second level transformation is used to replace the XNOR and MUX transformations found earlier (shown as s1, s2, s3 in the figure) with a full adder. A full adder contains a sum output and carry-output. By examining the inputs to XOR transformations, the technique identifies characteristics of carry signals and then attempts to prove whether the gates producing that signal form a carry. If so the structures are replaced with the more abstract adder constructs (shown pictorially in the dashed boxes and as code at the bottom of FIG. 3d).

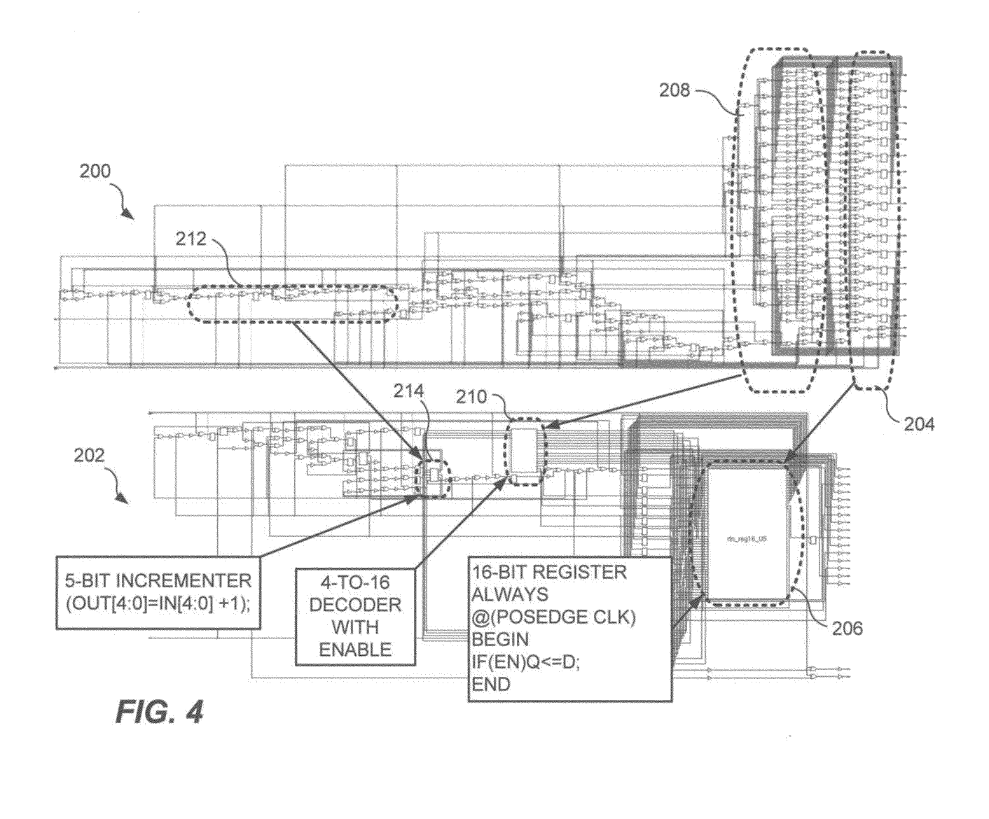

A representative sea of gates circuit 200 and its transformed netlist 202 is shown in FIG. 4. In the example shown in FIG. 4, a sixteen bit register is transformed from a sea of gates register 204 to an RTL register 206. Similarly, a 4-to-16 sea of gates decoder 208 is transformed into an RTL decoder 210 and an incrementer 212 is transformed into an RTL incrementer 214. This figure demonstrates an example of how the iterative nature of the technique. The register transformation shown (206) is the result of a first level transformation that identifies each flop's enable signal and proves that it does indeed load data based on the enable signal. The 16-bit register is then found as a second level search by grouping all flops that have the same enable signal. Similarly, the decoder (208) relies on previous “PRODUCT” transformations which are found by starting at each subcircuit and repeatedly walking the inputs as long as each input subcircuit implements the same logical AND or OR as the starting gate. Given each of these large groups implementing an AND or OR, the technique then analyzes the inputs to look for commonality and then groups these into a full decoder. Finally, the incrementer (214) is found only after first identifying XOR transformations, then grouping some number of them based on connectivity characteristics, and finally proving that the group does indeed form an incrementer using formal verification techniques, whereby we then replace the group of gates and XOR transformations with a single ADDER transformation as discussed in FIG. 3d above.

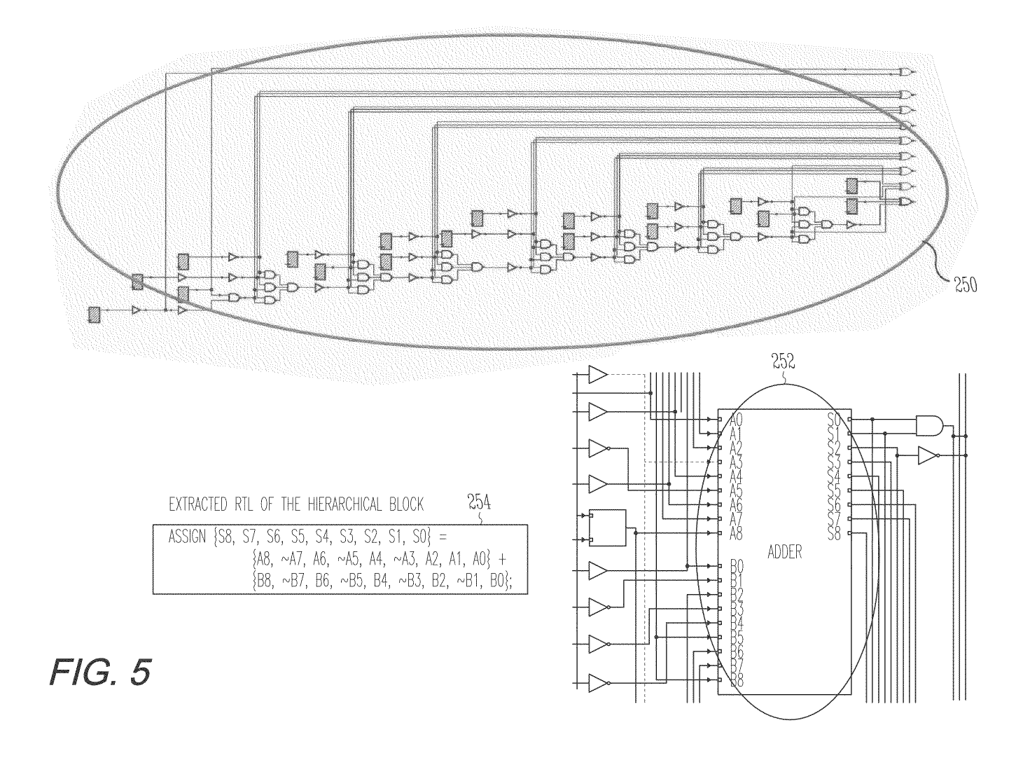

Another example transformation from a sea of gates circuit to a hierarchical netlist is shown in FIG. 5. In the example shown in FIG. 5, sea of gates 10-bit adder/subtractor 250 is transformed into an RTL adder/subtractor expression 254. The technique uses an approach like that described for the incrementer (214) above to find n-bit full adders (250 is a graphical depiction of the original sea-of-gates while 252 is a graphical depiction of the introduced transformation). The corresponding RTL is shown in 254, The technique therefore combines formal verification with structural patterns to provide a register-transfer level description of the adder transformation as well as the inversion levels (active-high or active-low) of each input.

An advantage of the approach described above is that the technique is performing a specific search for digital functionality, not structure (most of the previous approaches use structure to extract hierarchy or provide design insight). Such an approach takes advantage of domain knowledge of digital circuits and custom algorithms to identify functionality that is highly implementation agnostic. This makes the described approach computationally tractable.

In addition, the technique attempts to combine structural characteristics to prune the search space and use formal provers to verify functionality. This allows the technique to find very different implementations of the same function (e.g., a ripple-carry adder vs. carry-lookahead adder, etc.) and then replace it with a common, more abstract representation (e.g., in RTL format).

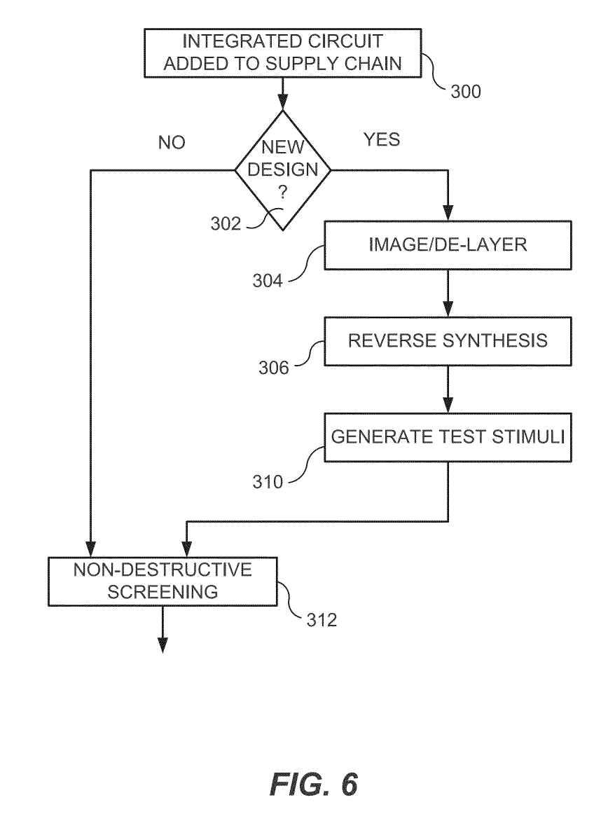

As noted above, in some embodiments, reverse synthesis is used to generate an RTL file from a sea-of-gates netlist. This has application in supply chain management. A technique of adding an integrated circuit to a supply chain tracking system is shown in FIG. 6. In the example embodiment of FIG. 6, an integrated circuit is added to the supply chain at 300. A check is made at 302 whether the part was previously used in a design and, if the part was not previously used in a design, the IC is imaged and delayered as necessary to extract a gate-level netlist. A technique of reverse synthesis is applied at 306. Test stimuli are generated at 310 and the IC is non-destructively screened at 312 using the test stimuli generated at 310.

If the check made at 302 indicates that the part was previously used in a design, control moves to 312 and the IC is non-destructively screened using the test stimuli previously generated for IC.

Such an approach guarantees that devices meet specifications, can be used to verify authenticity of a digital IC post fab (i.e., no malicious alterations, counterfeit parts, or trojans), can be used to compare the digital IC to its commercially available datasheet and can be used to determine the functionality of integrated circuits for which no design data is available.

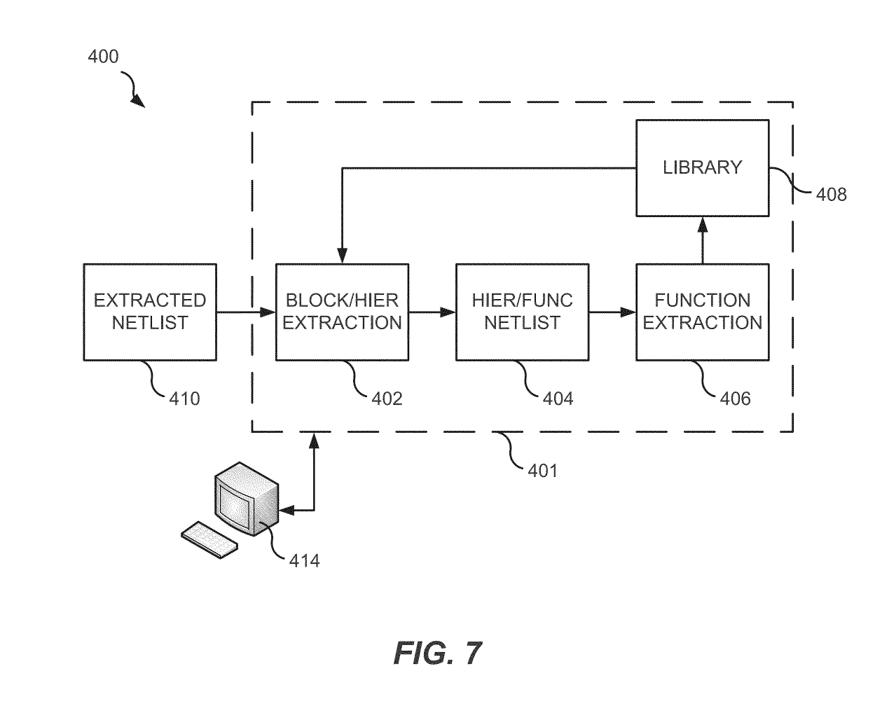

A system 400 for performing reverse synthesis of digital netlists is shown in FIG. 7. In the embodiment shown in FIG. 7, a computer 401 includes a reverse synthesis module that includes a block/hierarchical extraction module 402, a netlist storage module 404, a function extraction module 406 and a transformation library 408. A netlist 410 is read by computer 400 and iteratively processed by reverse synthesis module to extract hierarchy and functionality. In the example embodiment shown in FIG. 7, known transformations are stored in library 408 and are used by block/hierarchical extraction module 402 to identify potential transformations in netlist 410 as described above. The transformations are stored in netlist module 404.

In some embodiments, new functions are identified by function extraction module 406 and added to library 408. Such an approach has been shown to be effective in improving performance of system 400 in extracting hierarchy and functionality of a device under test (DUT). In some embodiments, computer 401 is connected to a terminal 414; a graphical user interface (GUI) on terminal 414 displays possible transformations when the voting is inconclusive, or when a new circuit is encountered.

Embodiments of the techniques described above, and components implementing those techniques, such as modules, may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the synchronous data system 100 may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method, comprising:
reading an input netlist of a device under review;
selecting a circuit to be transformed;
identifying transformation candidates using transformation specific criteria;
applying verification methods to prove the transformation is equivalent to the circuit being transformed;
if the candidate transformation is equivalent to the circuit being transformed, committing to the transformation; and
if the candidate transformation is not equivalent to the circuit being transformed, undoing the transformation.

2. The method of claim 1, wherein committing to the transformation includes replacing the circuit with a register-transfer level (RTL) description.

3. The method of claim 2, wherein the method further includes testing the RTL description to verify it operates like the device under review.

4. The method of claim 1, wherein the input netlist is expressed as a sea of gates.

5. The method of claim 1, wherein applying verification methods includes displaying candidate transformations to a user and receiving an approved transformation from the user.

6. The method of claim 5, wherein the approved transformation is a user-suggested transformation.

7. The method of claim 6, wherein committing to the transformation includes storing the user-suggested transformation in a library of transformation candidates.

8. The method of claim 7, wherein identifying transformation candidates includes selecting transformation candidates from the library.

9. The method of claim 1, wherein identifying transformation candidates includes selecting transformation candidates from a library of transformation candidates.

10. The method of claim 1, wherein selecting a circuit includes partitioning the netlist as a function of selected transformation specific criteria.

11. An article comprising a nontransitory computer-readable medium having instructions thereon, wherein the instructions, when executed in a computing device, implement the method of claim 1.

12. A reverse synthesis system, comprising a reverse synthesis module configured to receive a netlist and transform portions of the netlist into higher order functions representing the function of those portions of the netlist in accordance with the method of claim 1.

13. The system of claim 12, wherein the reverse synthesis system includes a computer, wherein the reverse synthesis module is implemented as a module within the computer.

14. The system of claim 13, wherein the computer includes a user interface and wherein the reverse synthesis module displays candidate transformations to a user via the user interface and receives approved transformations from the user via the user interface.

15. The system of claim 14, wherein the approved transformation is a user-suggested transformation.

16. A method of adding an integrated circuit to a supply chain tracking system, the method comprising:
identifying an integrated circuit;
determining whether the integrated circuit is already in the system;
if the integrated circuit is already in the system, performing non-destructive screening;
if the integrated circuit is not already in the system, imaging and delayering the integrated circuit to extract a gate-level netlist; reverse synthesizing the netlist to form a transformed netlist; and performing non-destructive screening on the integrated circuit as a function of the transformed netlist.

17. The method of claim 16, wherein reverse synthesizing the netlist includes:
selecting a circuit to be transformed;
identifying transformation candidates using transformation specific criteria;
applying verification methods to prove the transformation is equivalent to the circuit being transformed;
if the candidate transformation is equivalent to the circuit being transformed, committing to the transformation; and
if the candidate transformation is not equivalent to the circuit being transformed, undoing the transformation.

18. The method of claim 17, wherein committing to the transformation includes storing user-suggested transformations in a library of transformation candidates.

19. The method of claim 17, wherein identifying transformation candidates includes selecting transformation candidates from the library.

20. The method of claim 1, wherein selecting a circuit includes partitioning the netlist as a function of selected transformation specific criteria.

21. An article comprising a nontransitory computer-readable medium having instructions thereon, wherein the instructions, when executed in a computing device, implement the method of claim 16.

22. A supply chain tracking system, comprising a reverse synthesis module configured to identify and test an integrated circuit in accordance with the method of claim 16.
